(19) United States
(12) Patent Application Publication
(10) Pub. No.: US 2013/0247146 A1
(43) Pub. Date: Sep. 19, 2013

(54) AUTHENTICATION SYSTEM AND METHOD

(71) Applicant: Dennis Lyon, Oceanside, CA (US)

(72) Inventor: Dennis Lyon, Oceanside, CA (US)

(21) Appl. No.: 13/609,578

(22) Filed: Sep. 11, 2012

Related U.S. Application Data
(63) Continuation-in-part of application No. 13/464,036, filed on May 4, 2012.
Application No. 13/464,036 is a continuation of application No. 11/158,731, filed on Jun. 22, 2005, now abandoned.
(60) Provisional application No. 60/662,566, filed on Mar. 17, 2005.

(51) Int. Cl. H04L 29/06

(52) U.S. Cl. CPC H04L 63/105
USPC 726/3

(57) ABSTRACT

Various embodiments of authentication and information verification methods and apparatus are disclosed herein. In one embodiment, a server is described, comprising a communication interface for sending and receiving information to/from consumers and third parties, a memory for storing processor-executable instructions and one or more accounts, and a processor for executing the processor-executable instructions that cause the server to, receive electronic instructions, from a consumer, to create an account for a consumer, the account comprising a number of data fields, create an account in response to receiving instructions over the communication interface to create the account, the account comprising a number of data fields, store the account in the memory, assign an overall security level to the account, and increase the overall security level of the account in response to receiving an indication from a third party that the information provided to the third party is true.

### CLAIM OF PRIORITY

This application is a continuation-in-part and claims priority under 35 U.S.C. 120 to U.S. patent application Ser. No. 13/464,036 filed on May 4, 2004, which is a continuation of U.S. patent application Ser. No. 11/158,731, filed on Jun. 22, 2005, which claims priority to U.S. provisional application Ser. No. 60/662,566, filed on Mar. 17, 2005, the contents of all three applications incorporated by reference herein.

### BACKGROUND

I. Field of Use

The present application relates to the field of electronic authentication and authorization. More specifically, the present application relates to systems and methods for creating, configuring, and using an electronic authentication and authorization system for use by consumers.

II. Description of the Related Art

In today's modern culture, consumers increasingly make use of credit cards and debit cards to purchase goods and services, either at merchant locations or over the Internet. Additionally, consumers are embracing more and more electronic features that have become available in recent years. For example, an airline boarding pass may be electronically provided to a consumer's smart phone and then used to board an airplane. Electronic coupons, movie tickets, theater tickets, sporting event tickets, etc. are being used more and more by consumers because of the obvious convenience benefits. Each transaction typically involves some form of electronic authentication and/or authorization.

Authentication, in the broadest sense, is a process of confirming the truth of an attribute of a datum or entity. In electronic purchasing transactions, this typically involves confirming the identity of a person, e.g., confirming that the person conducting the transaction is who he or she purports to be. Authorization involves granting permission or authority. In an electronic transaction, for example, a person may be granted authorization to proceed with a transaction if one or more attributes of the transaction meet a predefined set of criteria. For example, if the purchase price is less than $1,000.00, a transaction may proceed. Otherwise, the transaction may be prevented due to the risk of a high-dollar loss being incurred as a result of fraud.

Several examples of authentication include the use of a usernames and passwords, challenge questions, and token devices. These authentication techniques have been used for years in online transactions between consumers and merchants. For example, a consumer may be required to enter a username and password to access an online banking account or credit card account. The consumer may additionally be required to enter a numeric code relating to a token device accessible to the consumer in order to further authenticate the consumer.

While consumers are enjoying the convenience of using smartphones and the Internet to conduct more and more of their purchases, there are several drawbacks to this convenience. First, it is becoming increasingly difficult for consumers to remember a multitude of usernames and passwords that are typically required for each particular credit/debit card account, merchant account, and other financial accounts. Second, in transactions requiring the use of a token, consumers may need to possess and access multiple tokens, each for authenticating consumers to a particular online merchant, financial institution, or other entity. Third, it is inconvenient and time-consuming for consumers to remember and input authentication information that satisfy the requirements of each particular merchant or financial institution.

It would be desirable to overcome the shortcomings of prior art electronic commerce systems to allow consumers greater convenience and security.

### SUMMARY

The embodiments described herein relate to authentication methods and apparatus. In one embodiment, a server is described for providing authentication services to consumers, comprising, a communication interface for sending information to consumers and third parties, and for receiving information from consumers and third parties over a wide area network, a memory for storing processor-executable instructions and one or more accounts, and a processor, coupled to the communication interface and the memory, for executing the processor-executable instructions that cause the server to, receive electronic instructions, from a consumer, to create an account for a consumer, the account comprising a number of data fields, create an account in response to receiving instructions over the communication interface to create the account, the account comprising a number of data fields, store the account in the memory, assign at least one security level to the account, and increase at least one of the security levels assigned to the account in response to receiving an indication from a third party that the information provided to the third party is true.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates an authentication system, comprising a user terminal, a credit agency server, a merchant server, an authentication server, and a wide-area network;

FIG. 2 is a functional block diagram of the authentication server shown in FIG. 1;

FIG. 3 is a flow diagram illustrating one embodiment of a method for creating an account, by a consumer, with the authentication server of FIGS. 1 and 2;

FIG. 4 is a flow diagram illustrating one embodiment of a method for verifying that at least some of the information stored in the consumer's account is true; and

FIG. 5 is a flow diagram illustrating one embodiment of a method for using the account created as described with reference to FIG. 3 and verified as described with reference to FIG. 4.

### DETAILED DESCRIPTION

The present description relates to a variety of embodiments of creating, configuring, and using an electronic authentication and authorization system. The system is used by consumers to store personal information for authentication purposes during transactions between consumers and merchants. The personal information may be accessed by a third party merchant either automatically (by designation by the consumer) or upon authorization from a consumer during a transaction with the third party merchant. Further, a third party may add information to consumers' accounts relating to personal or purchase transactions.

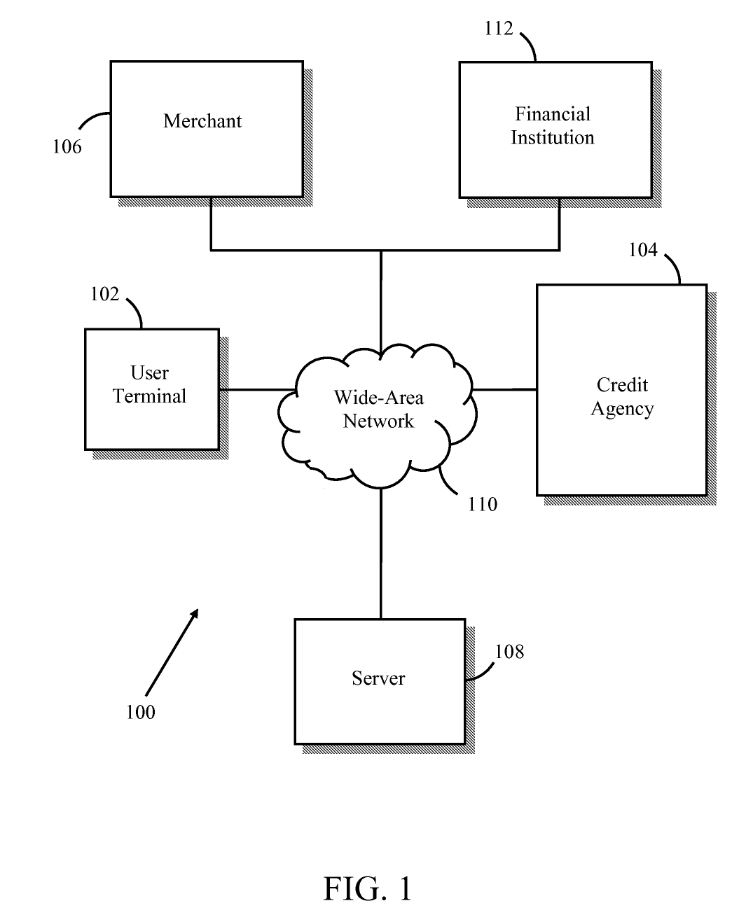

FIG. 1 illustrates an authentication system 100, comprising user terminal 102, credit agency 104, merchant 106, server 108, financial institution 112, and wide-area network 110. It should be understood that credit agency 104, merchant 106, and financial institution 112 represent businesses and/or a computer server associated with these businesses. Consumers may use system 100 to securely purchase goods or services from merchant 106 without having to provide sensitive information directly to the merchant, such as credit card information. In general, consumers may each create an account with server 108 via user terminal 102 in communication with server 108 via a wide area network 110. Server 108 may assign an initial overall security level to the account. Information in each account, provided by consumers, may be verified by a third party, such as credit agency 104. If at least some of the information is verified as being bona fide, legitimate, or otherwise belonging to a particular consumer, server 108 may increase the overall security level. An increased overall security level may allow certain transactions to occur, such as a merchant being able to add certain information to each consumers' account, as explained in greater detail below.

A consumer may create an account, or register with, server 108, for example, by visiting a website owned or operated by server 108, using user terminal 102. User terminal 102 typically comprises a laptop or desktop computer, tablet computer, smartphone, or any other electronic computing device capable of communication with server 108. User terminal 102 communicates with server 108 via a wide area network 110, for example, the Internet or a combination of the Internet and one or more other communication networks, such as a wired or wireless telephone network, satellite communications network, fiber optic network, and so on. Server 108 comprises one or more processors, communication interfaces, memory devices, and related hardware, software, and firmware needed for server 108 to provide authentication services to the consumer using user terminal 102, as explained in greater detail below.

To create a new account, a consumer typically sends a request to server 108 to create a new account, by sending information requested by server 108, such as a username, password, and/or other information, such as personal information about the consumer, for example a first and last name, address, telephone number, email address, and/or other personal information.

The information provided by the consumer is sent to server 108, and, in response, server 108 stores the information in an account that is stored in a memory associated with server 108. The account typically comprises a number of data fields populated by information provided by the consumer. In many cases, the consumer provides only a fraction of the information that is capable of being stored in the account. As will be explained later herein, information may be added by third parties and stored in the account created by the consumer.

After the account has been created, e.g., “initial registration”, server 108 may assign an overall security level to the account, such as “low”, “medium”, or “high”. These levels may be used by third parties to determine a confidence level that information in the account is authentic, e.g., verified as being accurate, belonging to a particular consumer, etc. The levels may be determined by evaluating a number of factors, including a quantity of information provided by the consumer or third party, the quality of the information provided by the consumer or third party, the type of information provided by the consumer or third party, and/or whether any of the information has been verified by a third party, for example, credit agency 104. For example, if the consumer provides a social security number to server 108 during the initial registration process, and at some future point, the social security number is verified as belonging to the particular consumer who provided it to server 108, then server 108 may increase the overall security level from “low” (e.g., unverified) to “high” (verified). This is an example of how the overall security level is increased based on a verification of a single “important” item of information in the account, e.g., information that may be closely guarded by a consumer. In another example, if a minimum number of information items are verified, regardless of whether they are deemed “important”, server 108 may increase the overall security level of the account. For example, if the minimum number of “unimportant” information is three, then verification of information such as a consumer's address, telephone number, and email address is all that is needed for server 108 to increase the overall security level of the account once this information has been verified by a third party.

A consumer may add to or modify his or her account at any time after the initial registration process. However, the account may also be modified (e.g., information added or changed) by one or more third parties. For example, after an account has been created with some initial information (e.g., first name, last name, address, email address, etc.), a consumer who provided the information may seek to have at least some of the information in the account verified by a trusted third party, such as credit agency 104. After the verification process, credit agency 104 may modify the account by providing information in addition to what was provided by the consumer, such as a social security number, security token information, credit card information, etc. Credit agency 104 comprises one of any known credit monitoring or reporting agencies, such as TransUnion, Equifax, or Experian. These agencies are viewed as trusted third parties that provide financial information to authorized individuals or businesses. For example, a landlord may contact credit agency 104 to inquire about a prospective tenant's credit history. A mortgage company may inquire about a consumer's credit score. Credit agencies typically maintain a database of information about consumers, such as a consumer's name, social security number, credit score, current and previous addresses, current and previous telephone numbers, current and previous email addresses, work history, credit history, etc.

If the consumer requests verification of one or more items of information stored in his or her account, the consumer may visit a website controlled by credit agency 104 using terminal 102. The consumer may be presented with a login page that requests login information from the consumer, e.g., a username, password, security token information, and/or other information to confirm that the person requesting verification is, in fact, the person associated with the account. Security token information typically comprises digital information provided by a security “token”, otherwise known as a hardware token, authentication token, USB token, cryptographic token, or key fob, typically physically provided to the consumer by a merchant or by a business associated with server 108. A token may also comprise a smartphone that is capable of receiving codes generated by an authenticating entity, such as server 108, or generating codes for comparison with a code generated by server 108. Security tokens are used to prove one's identity electronically (as in the case of a consumer trying to access their bank account). The token is used in addition to or in place of a password to prove that the consumer is who they claim to be.

Some tokens may store cryptographic keys, such as a digital signature, or biometric data, such as fingerprint minutiae. Some designs feature tamper resistant packaging, while others may include small keypads to allow entry of a PIN or a simple button to start a generating routine with some display capability to show a generated key number. Special designs include a USB connector, RFID functions or Bluetooth wireless interface to enable transfer of a generated key number sequence to a client system.

After the consumer has been authenticated by server 108, the server 108 may send the consumer a query requesting permission for server 108 to send certain information from the consumer's account to the credit agency 104 for verification. The information may have been previously designated, by the consumer, as information to be provided to third parties only after receiving authorization from the consumer, during a transaction with a third party. The consumer authorizes server 108 to send the information to credit agency 104 typically by clicking on the webpage in a designated area, and an indication is sent to server 108 indicating authorization to send the information to credit agency 104. Upon receiving the authorization from the consumer, server 108 transmits the information to credit agency 104 via wide area network 110.

In another embodiment, after the consumer has authenticated himself or herself to server 108 through the credit agency's website, credit agency 104 sends a message to server 108 requesting certain information required for credit agency 104 to complete the transaction with the consumer. For example, after the consumer has been authenticated by server 108, credit agency 104 may send a message to server 108 requesting that a name, current and previous addresses, and a social security number be provided to credit agency 104. Upon receiving the request from credit agency 104, server 108 provides any requested information to credit agency 104 that the consumer previously designated as information to be provided without needing authorization from the consumer. If some of the information requires authorization from the consumer prior to sending to third parties, as previously designated by the consumer, server 108 sends the consumer a query requesting such authorization from the consumer, through the credit agency website. The type of information requested may be displayed to the consumer via the credit agency website or it may be transmitted directly to the consumer via a wireless or wired phone call, text or SMS message, or some other form of communication directly to the consumer. The consumer authorizes server 108 to send the requested information either by clicking on the credit agency webpage in a designated area, or, in the case of direct communication with server 108, providing a response via the smartphone. In any case, an indication is sent to server 108 indicating permission to send the prompted information to credit agency 104. Upon receiving the authorization from the consumer, server 108 transmits the information to credit agency 104 via wide area network 110.

After credit agency 104 has received the information as described above, it may display a message to the consumer in accordance with the particular transaction that the consumer wishes to accomplish. For example, if the user wishes to verify some of the information that the consumer previously provided to server 108, credit agency 104 may request that the consumer give permission to verify some of the information in the consumer's account, and list the informational items that credit agency 104 wishes to verify. Alternatively, or in addition, credit agency 104 may request permission from the consumer to add information to the consumer's account stored by server 108.

After the consumer gives permission for credit agency 104 to verify and/or add information in/to the consumer's account, credit agency 104 compares the information provided by server 108 to information previously obtained by credit agency 104 through other sources to verify at least some of the information in the consumer's account is accurate, authentic, and/or belonging to the consumer. In one embodiment, if all of the information provided by server 108 matches the previously-acquired information obtained by credit agency 104, then an indication is sent to server 108 indicating that the information received by credit agency 104 from server 108 has been verified. In another embodiment, if some of the information was not able to be verified, credit agency 104 provides an indication to server 108 of the information that was able to be successfully verified, in one embodiment, itemized by each piece of information that was successfully verified and/or itemized information that was not able to be verified. In addition, credit agency 104 may provide an indication of information that did not match information previously obtained by credit agency 104. In any case, authentication serve 108 receives the indication and, as a result, may increase the overall security level of the consumer's account based on a predetermined set of criteria, such as the quantity, quality, and/or sensitivity of the information that was verified by credit agency 104. Alternatively, in another embodiment, credit agency 104 may send a command to server 108 to increase the overall security level of the account by one or more increments, or command server 108 to increase the overall security level to a particular level. In either case, server 108 may add information to the consumer's account indicating what information was verified, by whom, and on what date and/or time the information was verified.

Credit agency 104 may, either alternatively or in addition to sending a verification indication to server 108 as described above, add information to the account by transmitting a message to server 108 indicating the information to be added. For example, if upon initial registration, the consumer only provided his or her first and last name, a current address, and a date of birth, credit agency 104 may add the consumer's social security number to the consumer's account if the consumer's name, address, and date of birth has been verified as accurate and authentic by credit agency 104. Upon receiving the information to be added to the customer's account from credit agency 104, server 108 adds the information to the consumer's account and, in one embodiment, additionally stores an indication that the information was provided by a third party, an indication that the social security number was verified, an identification of the entity that provided the verification and/or the date of verification. Either credit agency 104 or server 108 may further designate the information provided by credit agency 104 as being automatically provided to any subsequent request from a third party or only provided to such third parties upon authorization from the consumer.

Information may be added to consumers' accounts by a variety of third parties, such as merchants, service providers, financial institutions, credit agencies, etc. For example, credit card information may be added by a financial institution. In this case, after a consumer has established an account with server 108, the consumer may wish to apply for a credit card by visiting a website owned or operated by a financial institution that issues credit cards in their normal course of business. The website provides the consumer with a login area where the consumer enters his or her identification information, e.g., authentication information such as username, password, and/or security token information, in order to log into server 108. However, in some cases, additional information may be required by the financial institution before certain transactions may be conducted, given the high rate of credit card fraud. For example, multiple-factor authentication may be required by the financial institution, and/or the financial institution may require an overall security level of the consumer's account to be equal to or greater than a certain level during a transaction involving the issuance of a new credit card with the consumer. Multi-factor authentication refers to an authentication procedure where at least two of the three widely-recognized authentication factors are used to perform authentication: “something the user knows”, “something the user has”, and “something the user is”.

When the username, password, and/or security token information is sent to server 108 by the consumer through the website operated or owned by the financial institution, additional information may also be sent by the financial institution, indicating a minimum overall security level required to process the transaction between the consumer and the financial institution. Further, the financial institution may request that server 108 send certain information to the financial institution from the consumer's account in order to complete the transaction between the financial institution and the consumer. When this information is received by server 108, server 108 evaluates the information to determine whether or not the username, password, and/or token information matches information in the consumer's account and/or generated by server 108. In addition, server 108 determines whether the consumer's account comprises an overall security level equal to or greater than that required by the financial institution. If so, then server 108 sends information in the customer's account to the financial institution as requested by the financial institution. In another embodiment, server 108 sends a message to the financial institution indicating successful authentication of the consumer, and requests that the financial institution indicate what information is needed by the financial institution to conduct the transaction between the financial institution and the consumer. Any information that has been designated by the consumer as “prompt” in the account is not provided to the financial institution until the consumer has provided authorization to authorization server 108 during the transaction to provide the information to the financial institution.

Once the financial institution receives information from the consumer's account, it may decide to issue the consumer a new credit card. In this case, the financial institution may send a message to server 108 to add credit card information to the consumer's account, such as a credit card number, expiration date, an identification of the financial institution, a credit card security code, etc. The financial institution may additionally add new security token information to the consumer's account, e.g., information pertaining to a new security token that is physically provided to the customer by the financial institution. Prior to adding this information, in one embodiment, the consumer is prompted to authorize the addition of the credit card information and/or token information to his or her account. After the credit card/token information has been added to the consumer's account by server 108, it may be accessed by third party merchants to pay for goods and services that the consumer purchases in subsequent transactions.

Other types of information may be added to the consumer's account, such as information pertaining to travel, such as airline boarding pass information, train ticket information, ferry pass information, and the like, directly by merchants offering such travel tickets. In this example, the consumer may use user terminal 102 to access a merchant server 106 owned or operated by a merchant. Examples of merchants may include virtually any provider of goods or services. In the present example, the merchant is a provider of travel services, for example, an airline or travel website, such as Travelocity, Expedia, Orbitz, etc. Once the consumer has selected his or her itinerary, the consumer may pay the airline or travel website via the account stored at authorization server 108. This may be accomplished by the airline or travel website providing a login and/or authentication section for the consumer to log into, and/or authenticate himself/herself, to server 108. The consumer enters the requested identification/authentication information (e.g., username, password, token information, etc.) and then the website provides the information to server 108 for verification. Once the consumer has been authenticated/logged into server 108, the website may query the consumer whether he or she would like to use one of the credit cards on file at authorization server 108 to pay for the consumer's travel ticket(s), and further may present the consumer with a selection of credit cards that are available for use and whose information is stored in the consumer's account. The consumer may select one of the credit cards for payment and provided the selection to server 108 via the merchant's website and wide area network 100. In response, the selected credit card is used to pay for the goods or services purchased by the consumer.

Once the goods or services, such as travel ticket(s), have been purchased, the merchant server 106 provides information relating to the travel ticket(s) to server 108 via wide area network 110. This may include boarding pass information, a code indicative of the ticket(s) (e.g., bar code, alpha-numeric code, etc.), iteniary information, date of purchase, airport information, etc. The travel information may be used by the consumer when the consumer is about to embark on his or her trip. For example, the consumer may access his or her account stored in server 108 to retrieve boarding pass information that may be used to board an aircraft. The boarding pass information may be transmitted by server 108 to a smartphone carried by the consumer and be presented to, for example, a bar code scanner just prior to the consumer boarding an aircraft.

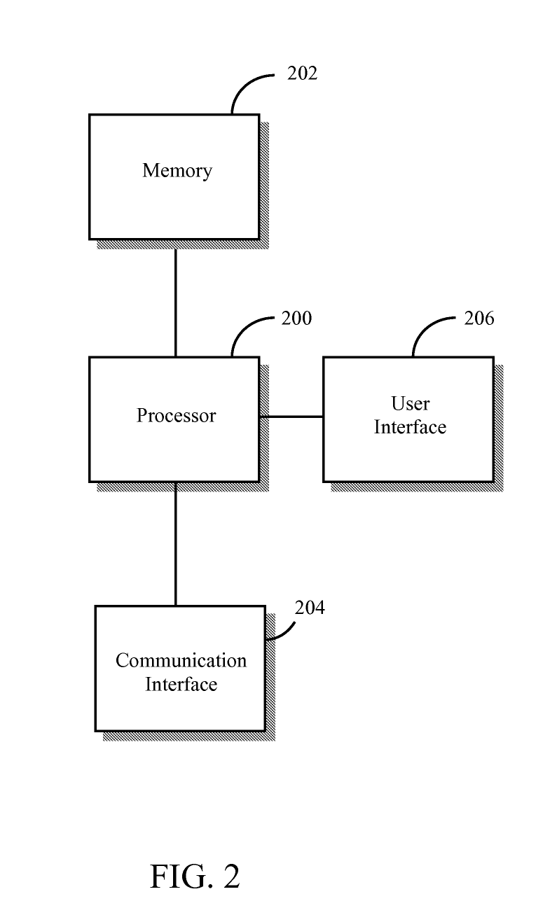

FIG. 2 is a functional block diagram of server 108. Specifically, FIG. 2 shows processor 200, memory 202, communication interface 204, and user interface 206. It should be understood that not all of the functional blocks shown in FIG. 2 are required for operation of server 108 (for example, user interface may not be necessary), that the functional blocks may be connected to one another in a variety of ways, and that not all functional blocks necessary for operation of server 108 are shown (such as a power supply), for purposes of clarity.

Server 108 may comprise virtually any commercially-available servers on the market today, including the P4200IP server system manufactured by Intel Corporation of Santa Clara, Calif. The server 108 comprises processor 200, which is configured to provide general operation of server 108 by executing processor-executable instructions stored in memory 202, for example, executable code. Processor 200 typically comprises a general purpose processor, such as any of the Xenon® family of processors manufactured by Intel Corporation of Santa Clara, Calif., although any one of a variety of microprocessors, microcomputers, and/or microcontrollers may be used alternatively.

Memory 202 comprises one or more information storage devices, such as hard drives, RAM memories, ROM memories, flash memories, and/or virtually any other type of electronic, optical, or mechanical memory device. Typically, memory 202 comprises more than one type of memory. For example, memory 202 may comprise a ROM memory used to store processor-executable instructions for operation of server 108, plus RAM memory or hard drives to store consumer account information.

Communication interface 204 is electronically coupled to processor 200 and comprises electronic circuitry necessary for server 108 to communicate with various entities such as user terminal 102, credit agency 104, and various merchants 106, among others. Typically, communication interface comprises hardware, software and/or firmware necessary to receive data packets sent via one or more commonly-used network protocols, such as the well-known TCP/IP suite of protocols. Alternatively, or in addition, communication interface could comprise electronics and supporting software/firmware to support other well-known communication types, including wireless telephone communications, satellite communications, fiber-optic communications, and so on. As data is received by communication interface 204, they may be processed by providing them to processor 200. When consumer account information is retrieved by processor 200 during normal operation of server 108, it is generally placed into data packets where they are provided to communication interface for transmission across wide area network 110.

User interface 206 is coupled to processor 200 and is used to allow an individual to control operation of server 108 and/or to receive information from server 108. User interface 206 may comprise one or more pushbuttons, switches, sensors, keypads, and/or microphones that generate electronic signals for use by processor 200 upon initiation by a user. User interface 206 may additionally comprise one or more seven-segment displays, a cathode ray tube (CRT), a liquid crystal display (LCD), one or more light emitting diode displays (LEDD), one or more light emitting diodes (LEDs), light arrays, or any other type of visual display. Further, the electronic display could alternatively or in addition comprise an audio device, such as a speaker, for audible presentation of information to a user. Of course, the aforementioned items could be used alone or in combination with each other and other devices may be alternatively, or additionally, used.

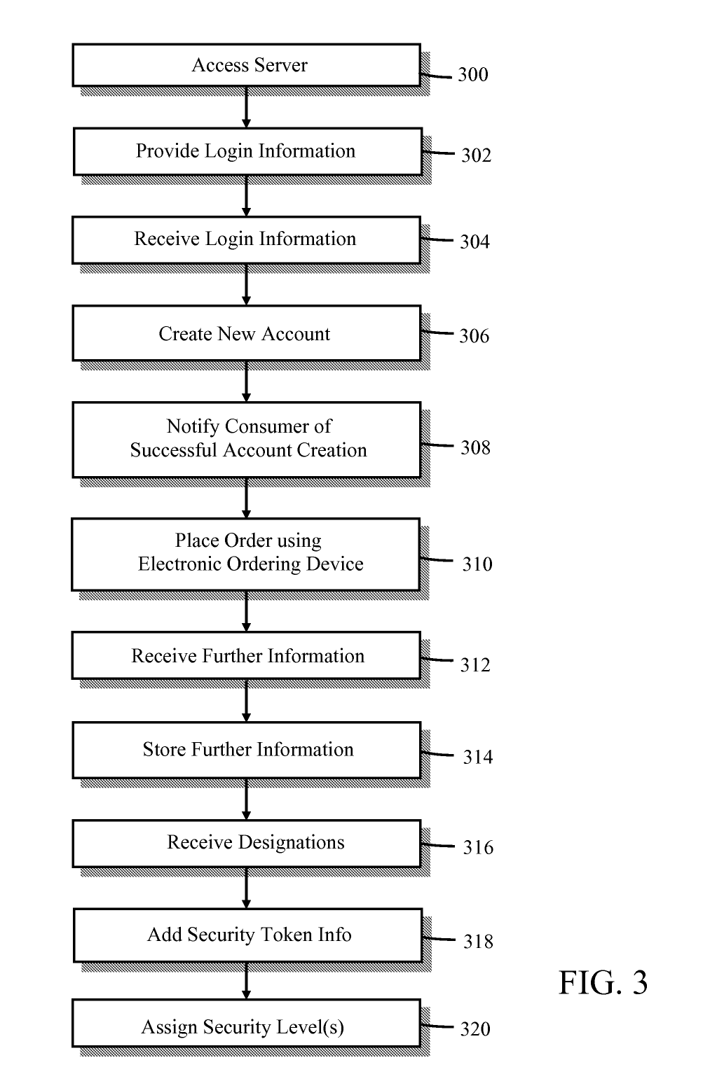

FIG. 3 is a flow diagram illustrating one embodiment of a method for creating an account, by a consumer, with server 108. The method is implemented by a processor, such as processor 200 shown in FIG. 2 executing processor-readable instructions stored in a memory, such as memory 202 shown in FIG. 2. It should be understood that in some embodiments, not all of the steps shown in FIG. 3 are performed and that the order in which the steps are carried out may be different in other embodiments. It should be further understood that some minor method steps have been omitted for purposes of clarity.

At block 300, a consumer accesses server 108 using terminal 102, which may comprise a desktop or laptop computer, tablet computer, smartphone, or the like. Terminal 102 is in communication with server 108 via wide area network 110, such as the Internet. Typically, access to the consumer is provided via a website offered by server 108 or a related entity.

At block 302, the consumer opens the account by providing login information to terminal 102 which is then provided to server 108 via wide area network 110. The login information typically comprises a username and password, although other information could be used, such as an email address and a password.

At block 304, the login information is received by server 108. In response, at block 306, server 108 creates a new account for the consumer, by storing at least the login information in memory 202. Typically, server 108 allows the consumer to provide many types of information, such as personal information (e.g., name, address, telephone numbers, email addresses, a social security number, etc.), financial information (e.g., a bank account number, a credit card number, etc.), and electronic purchases (e.g., an airline ticket represented as an electronic boarding pass, theater ticket represented digitally, etc.).

At block 308, server 108 provides an indication to the consumer, via wide area network 110 and terminal 102, that a new account has been created for the consumer. In one embodiment, server 108 presents a visual representation of the account to the user, comprising a number of data fields, tabs, drop-down menus, etc. that allow the consumer to view, modify, or add information in the data fields.

At block 310, the server 108 may receive additional information from the consumer relating to the consumer's personal information, financial information, or electronic purchases. For example, the consumer may provide his or her name, address, telephone number and email address to server 108, where it is then provided to processor 200.

At block 312, processor 200 stores the additional information in memory 202 in designated data fields in the account.

At block 314, server 108 may receive one or more designations from the consumer, designating at least some of the information provided at block 310 as “allow”, “restrict”, or “prompt”, referring to whether a particular data field's contents are allowed to be provided to third parties, not allowed to be provided to third parties, or allowed to be provided to third parties only if the consumer provides authorization during a transaction with a third party, as will be explained later herein.

At block 316, server 108 receives instructions from the consumer that the consumer would like to add one or more security tokens to the account. The consumer may provide this information by navigating to a particular section of the visual representation of the account provided by server 108 via terminal 102. For example, the consumer may select a token type (e.g., USB, RFID, smart card, cell phone, etc.) and then enter information, such as a crypto key, telephone number, etc. pertaining to a security token that the consumer has in his or her possession. In one embodiment, the consumer may designate the security token as a “master” token that is used only by the consumer to authenticate himself/herself to server 108 for account maintenance by the consumer.

At block 318, server 108 may receive a designation, from the consumer, designating any of the security tokens as either required to be used during a subsequent authentication procedure, or not required to be used during a subsequent authentication procedure. If a security token is required to be used during a subsequent authentication procedure, the consumer will have to provide information from the security token that the consumer has in his or her possession during a transaction among a third party and server 108.

At block 320, processor 200 assigns one or more security levels to the account, based on one or more factors, such as the quantity of information provided, the “quality” of information provided (e.g., sensitive information such as a social security number, email address, physical address, etc.), or whether any of the information in the account has been verified as authentic by a trusted third party, such as credit agency 104. Typically, if none of the information in the account has been verified as authentic, as is usually the case in a newly created account, processor 200 assigns a “low” overall security level to the account, indicating to third parties of a low level of confidence that the information in the account is authentic. In another embodiment, each data field may be assigned an individual security level based on the afore-mentioned factors. For example, during an initial account setup, most of the information provided is classified as a relatively low level of security, because it has not been verified by an independent, trusted third party.

At this point, the consumer's account has been created and stored in memory 202 by processor 200.

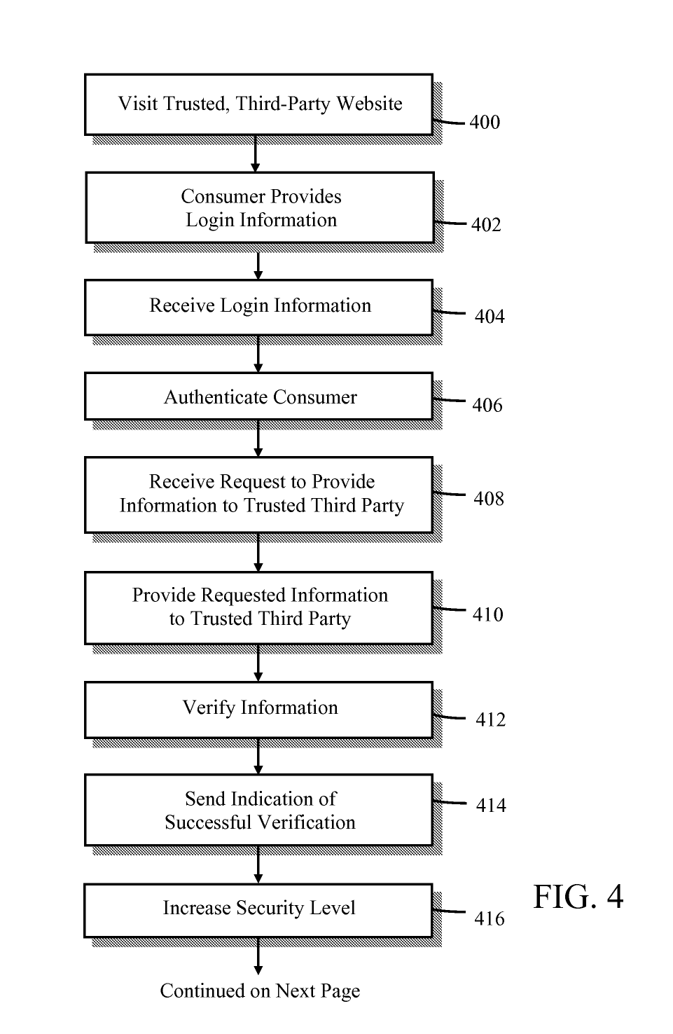

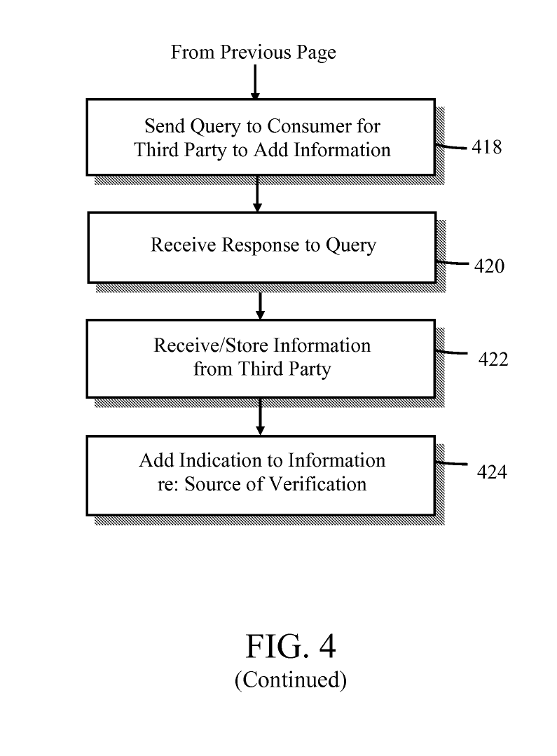

FIG. 4 is a flow diagram illustrating one embodiment of a method for verifying that at least some of the information stored in the consumer's account is true. The method is implemented by a processor, such as processor 200 shown in FIG. 2 executing processor-readable instructions stored in a memory, such as memory 202 shown in FIG. 2. It should be understood that in some embodiments, not all of the steps shown in FIG. 4 are performed and that the order in which the steps are carried out may be different in other embodiments. It should be further understood that some minor method steps have been omitted for purposes of clarity.

At block 400, a consumer who has already created an account with server 108 uses terminal 102 to visit a website owned, operated, or otherwise provided by a trusted third party, such as credit agency 104, a bank, a governmental body, such as a Department of Motor Vehicles, Social Security Administration, etc. The website is hosted by a server owned, operated, or otherwise provided by the trusted third party.

At block 402, the consumer provides login information to the website so that the website may provide the login information to server 108 on behalf of the consumer. In another embodiment, a login “window” is presented to the consumer that directly provides the login information to server 108, without being routed through the credit agency's server. The login information may comprise a username and password, and, in one embodiment, security token information provided by a security token in possession of the consumer. The necessity of providing security token information at block 402 is based on whether the consumer provided information about the security token in a previous transaction with server 108, and whether the consumer designated the security token as required during an authentication procedure.

At block 404, the login information is received by server 108 and at block 406, the login information is compared to information stored in memory 202 to authenticate the customer.

At block 408, a request to provide information in the consumer's account to the trusted third party is received from the third party server in response to a successful login, by the customer, to the customer's account. If the information requested by the third party server has been previously designated by the consumer as being available to third parties, then that information is automatically provided by server 108 to the trusted third party server.

However, if at least some of the information being requested by the trusted third party server at block 406 has been previously designated by the consumer as not being allowed to be shared with third parties, then that information is not provided to the trusted third party server by server 108, and a message may be generated, either by server 108 or by the trusted third party server, indicating to the consumer that the verification cannot continue, because at least some of the information required for verification by the trusted third party is not available from server 108.

Further, if at least some of the information being requested by the trusted third party server at block 408 has been previously designated by the consumer as allowed to be provided to third parties only if the consumer provides authorization during a transaction between the consumer and a third party, then, in one embodiment, server 108 sends a message to the consumer via the trusted third party website requesting authorization from the customer to provide this information to the trusted third party server. In another embodiment, the message is sent directly to the consumer via, for example, a text message to the consumer's smartphone, requesting authorization to provide the information being requested by server 108. Along with the message, server 108 typically provides an identification of the type of information being requested by the trusted third party, e.g., social security number, address, email address, etc. If the consumer agrees to provide the requested information to the trusted third party, an affirmative response is provided to server 108, either via the trusted third party website, or directly from the consumer, for example, by replying to the request for authorization text sent by server 108.

At block 410, server 108 provides the information requested by the trusted third party server if the information is designated as available and/or the consumer has given permission for the information to be provided to the trusted third party, as explained above.

At block 412, the trusted third party verifies, or authenticates, the information provided by server 108 at block 410 to be valid and belonging to the customer to whom it purports to be. Verification is typically performed by comparing the information provided by server 108 to information that was independently obtained by the trusted third party. For example, a credit agency is typically provided with personal and financial consumer information from financial institutions when consumers apply for credit cards or loans.

At block 414, if the information provided to the trusted third party server is determined to be verified as accurate and authentic e.g., belonging to the consumer, a message is sent to server 108 from the trusted third party server indicating that the verification was successful. In one embodiment, an indication of the type of data that was verified is also included, such as “social security number, name, and address verified”. In response, at block 416, processor 200 may increase the overall security level of the consumer's account, based on the verification by the trusted third party, or it may increase a security level for only the information that was verified. For example, the overall security level may be changed from “low” to “high”, indicating a greater confidence that the information in the account is accurate and belonging to the consumer. In other embodiments, the assigned security level can comprise a numerical system, for example “1” being a low level of security and “5” being the highest level of security, with intervening numerals indicating security levels between those two limits. Other systems to indicate security levels can be used in the alternative.

After verification of the consumer's information, he trusted third party server may wish to provide information to the consumer's account that was not previously provided by the consumer. For example, if the consumer had opened an account previously with server 108 and provided a name, address, phone number, and email address to server 108, and the trusted third party server verified this information and also determined a corresponding social security number belonging to the consumer, the trusted third party may wish to add this information to the consumer's account. Thus, at block 418, in one embodiment, the trusted third party server provides a message to the consumer via the trusted third party website, asking the consumer if he or she would like the trusted third party to add information to the consumer's account and may identify the information proposed for addition.

At block 420, the consumer may provide an indication to server 108, via terminal 102 and the trusted third party website, allowing the trusted third party server to add the information to the consumer's account.

At block 422, processor 200 receives the additional information from the trusted third party server via wide area network 110 and stores it in the consumer's account in memory 202.

At block 424, processor 200 may add an indication in association with at least some of the information that was verified by the trusted third party server, identifying a name of the entity that performed the verification (e.g., Equifax, TransUnion, etc.). Other information may be added as well, such as the date and/or time of the verification.

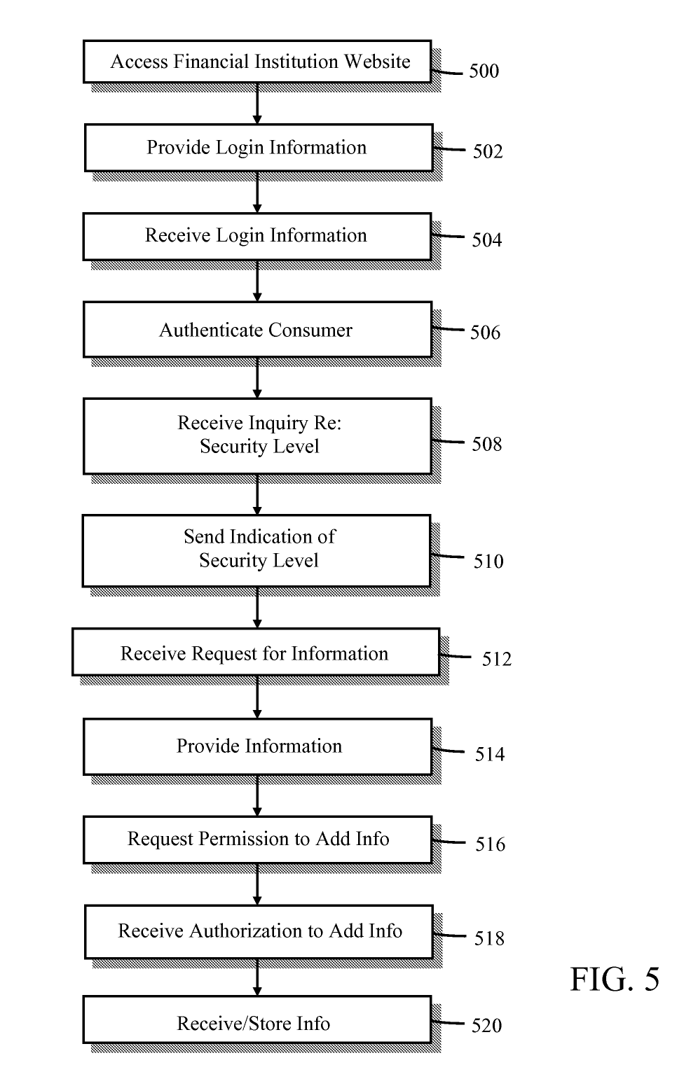

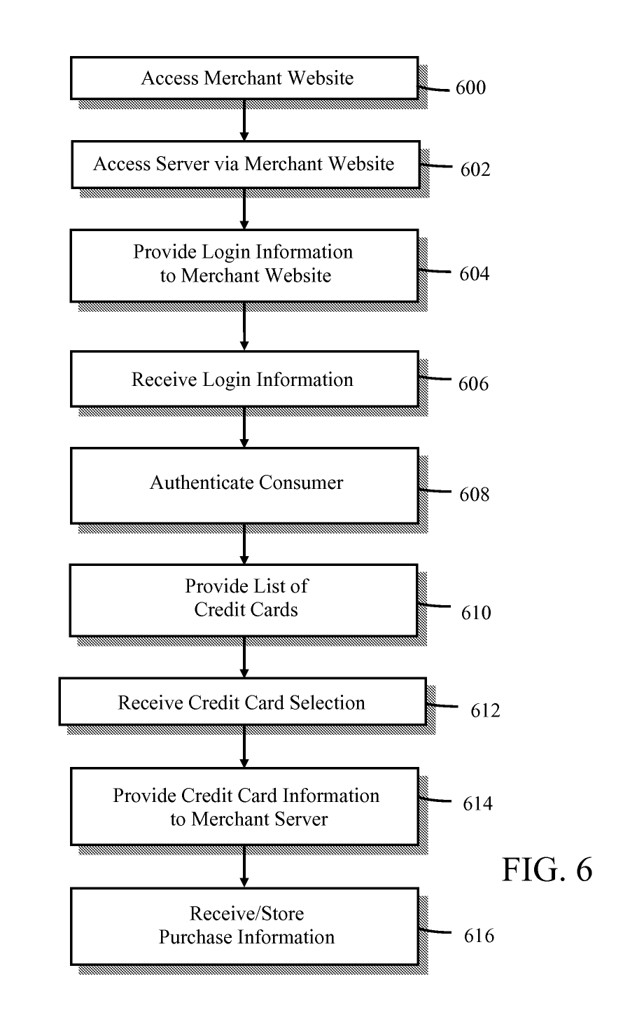

FIG. 5 is a flow diagram illustrating one embodiment of a method for using the account created as described with reference to FIG. 3 and verified as described with reference to FIG. 4, above. The method is implemented by a processor, such as processor 200 shown in FIG. 2 executing processor-readable instructions stored in a memory, such as memory 202 shown in FIG. 2. It should be understood that in some embodiments, not all of the steps shown in FIG. 5 are performed and that the order in which the steps are carried out may be different in other embodiments. It should be further understood that some minor method steps have been omitted for purposes of clarity.

At block 500, a consumer who has already created an account with server 108 uses terminal 102 to visit a website owned, operated, or otherwise provided by financial institution 112, such as a bank or credit card issuer. The website is hosted by a server owned, operated, or otherwise provided by financial institution 112. The consumer may click on a portion of the website in order to, for example, apply for a new credit card. The website may, in response, may provide the consumer with a way to login to the consumer's account stored by server 108.

In one embodiment, financial institution 112 may require particular authentication information from the consumer for authentication to server 108. For example, the financial institution may require two or more authentication “factors”, e.g., “something the user knows”, “something the user has”, and “something the user is”. Thus, the financial institution may require a username and password, plus security token information from the consumer in order to conduct the application for a new credit card. If the financial institution requires such authentication information, the financial institution server may present entry fields to the consumer, via the financial institution web site, mandating the entry of authentication information required by the financial institution.

At block 502, the consumer provides login information to the website so that the website may provide the login information to server 108 on behalf of the consumer. In another embodiment, a login “window” is presented to the consumer that directly provides the login information to server 108, without being routed through the credit agency's server. The login information may comprise a username and password, and, in one embodiment, security token information provided by a security token in possession of the consumer. In some embodiments, the financial institution requires certain authentication information from the consumer, such as two-factor authentication. The necessity of providing security token information at block 502 is based on whether the consumer provided information about the security token in a previous transaction with server 108, and whether the consumer designated the security token as required during an authentication procedure.

At block 504, the login information is received by server 108 and at block 506, the login information is compared to information stored in memory 202 to authenticate the customer.

At block 508, server 108 receives an inquiry from the financial institution on whether the overall security level of the customer's account is equal to, or greater, than a level required by the financial institution. This requirement may be imposed by financial institutions, or other merchants, to reduce the risk of fraud. In another embodiment, server 108 receives an inquiry regarding the security level of one or more data fields, e.g., whether one or more items of information stored in respective data fields have individually achieved a minimum security level status. A overall security level may be assigned to the account by server 108 in response to some or all of the information in the account being verified by a third party, or a security level may be assigned to one or more data fields, indicating a level of trust of information in these data fields, typically as a result of being verified by the third party.

At block 510, server 108 sends the financial institution an indication of the consumer's overall security level, either by sending an indication of the level itself, such as “High”, or simply an acknowledgment that the overall security level of the customer's account meets or exceeds the level required by the financial institution (or fails to do so).

In another embodiment, no indication is sent, and server 108 simply provides information requested by the financial institution if the minimum security level is met, as described below.

At block 512, a request is received by server 108 to provide information in the consumer's account to the financial institution in response to a successful login, by the customer, to the customer's account. The requested information may have been previously designated by the consumer as being available to third parties, as not being available to third parties, or available to third parties only if the consumer provides authorization during a transaction between the consumer and a third party. The requested information is provided to the financial institution at block 514 in accordance with the description with respect to blocks 408-410 in FIG. 4, above.

At block 516, assuming that a new credit card is issued by the financial institution, the financial institution server may ask the consumer for permission to add the new credit card information to the consumer's account, by presenting a visual query to the consumer on the financial institution's website. It may additionally ask the consumer to give permission to add a new security token (in the form of a physical credit card provided to the consumer by the financial institution at a later date) to the consumer's account in accordance with the credit card.

At block 518, the consumer may authorize addition of the credit card information and new security token to the user's account by providing an indication to the financial institution's website, where the authorization is then provided to sever 108.

At block 520, server 108 receives and stores the credit card information and/or security token information from the financial institution and provides it to processor 200, with the credit card information typically comprising a credit card number, expiration date, issue date, the name of the issuing financial institution, etc. The security token information may comprise the name of the issuing financial institution, a security token type (e.g. magnetic stripe on plastic card), a version number, etc.

FIG. 6 is a flow diagram illustrating one embodiment of a method for using the account created as described with reference to FIG. 3, verified as described with reference to FIG. 4, and having credit card information stored therein, as described above. The method is implemented by a processor, such as processor 200 shown in FIG. 2 executing processor-readable instructions stored in a memory, such as memory 202 shown in FIG. 2. It should be understood that in some embodiments, not all of the steps shown in FIG. 6 are performed and that the order in which the steps are carried out may be different in other embodiments. It should be further understood that some minor method steps have been omitted for purposes of clarity.

At block 600, a consumer who has already created an account with server 108 uses terminal 102 to visit a website owned, operated, or otherwise provided by a provider of goods or services, merchant, retailer, etc., in this example, an airline. It should be understood, however, that the following description can apply to a great number and type of other merchants. The website is hosted by a server owned, operated, or otherwise provided by the airline. The consumer may use the airline's website to select airline tickets. After the tickets have been selected, they may be purchased using the consumer's account stored at server 108 as follows.

At block 602, after selecting one or more flights for purchase, the consumer may click on an icon presented by the airline's website for paying for the airline tickets using the consumer's account stored in server 108. The consumer is then presented with, for example, text entry boxes for entering the customer's authentication information, as required by the airline.

As in the method described in association with FIG. 5, in one embodiment, the airline may require particular authentication information from the consumer for authentication to server 108. For example, the airline may require two or more authentication factors in order to proceed with the transaction. The airline's website may present entry fields to the consumer mandating entry of particular authentication information and/or a number of different types of authentication information (such as two-factor).

At block 604, the consumer provides login information to the website so that the website may, in turn, provide the login information to server 108 on behalf of the consumer. In another embodiment, a login “window” is presented to the consumer that directly provides the login information to server 108, without being routed through the credit agency's server. The login information may comprise a username and password, and, in one embodiment, security token information provided by a security token in possession of the consumer.

At block 606, the login information is received by server 108 and at block 608, the login information is compared to information stored in memory 202 to authenticate the customer.

At block 610, Assuming a successful login at block 608, server 108 may provide an indication to the airline's website, for presentation to the consumer, a list of one or more credit cards available for the consumer and, in one embodiment, identification information of each credit card, such as the last four digits of each credit card or, in another embodiment, the entire credit card number.

At block 612, server 108 receives an indication from the consumer, via the airline's website, of which credit card to use for purchasing the airline tickets.

At block 614, server 108 provides the selected credit card information to the airline server in order for the consumer to complete the purchase. Airline server, in response, debits the credit card in an amount equal to the transaction total.

At block 616, server 108 may receive information regarding the just-purchased airline tickets, such as a receipt, itinerary, confirmation code, or a boarding pass, and store the information in the account. The boarding pass typically comprises a numeric or alpha-numeric sequence that may be provided to the consumer's smart phone for use as an electronic boarding pass that may be scanned by airline personal as the consumer boards an aircraft. Any information stored in the consumer's account may typically be accessed by the consumer or by a third party as the consumer conducts a future transaction with a third party.

The methods or algorithms described in connection with the embodiments disclosed herein may be embodied directly in hardware or embodied in processor-readable instructions executed by a processor. The processor-readable instructions may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components.

Accordingly, an embodiment of the invention may comprise a computer-readable media embodying code or processor-readable instructions to implement the teachings, methods, processes, algorithms, steps and/or functions disclosed herein.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

I claim:

1. A server for providing authentication services to consumers, comprising:
a communication interface for sending information to consumers and third parties, and for receiving information from consumers and third parties over a wide area network;
a memory for storing processor-executable instructions and one or more accounts; and
a processor, coupled to the communication interface and the memory, for executing the processor-executable instructions that cause the server to:
receive electronic instructions, from a consumer, to create an account for a consumer, the account comprising a number of data fields;
create an account in response to receiving instructions over the communication interface to create the account, the account comprising a number of data fields;
store the account in the memory;
assign at least one security level to the account; and
increase at least one of the security levels assigned to the account in response to receiving an indication from a third party that the information provided to the third party is true.

2. The server of claim 1, wherein the processor-executable instructions that cause the server to increase at least one of the security levels assigned to the account further comprise instructions that cause the server to:
receive login information from the third party on behalf of the consumer over the communication interface;
authenticate the consumer using the login information;
receive a request for information in the account from the third party;
send the information to the third party; and
receive an indication from the third party that the information provided to the third party is true.

3. The server of claim of 1, wherein the processor-executable instructions further comprise instructions for the server to:
receive authorization from the consumer to allow the third party to add new information to the account;
receive the new information from the third party; and
store the information in one of the data fields in the account.

4. The server of claim 1, wherein the processor-executable instructions further comprise instructions for the server to:
receive an indication of a minimum security level required by the third party to complete a transaction with the consumer; and
send the indication to the third party;
wherein a transaction with the consumer is performed by the third party only if at least one of the security levels is equal to or greater than a level required by the third party to process the transaction.

5. The server of claim 1, wherein the processor-executable instructions further comprise instructions for the server to:
increase the security level of the account as a whole.

6. The server of claim 1, wherein the processor-executable instructions further comprise instructions for the server to:
increase the security level of only some of the information stored in the account.

7. The server of claim 1, wherein the processor-executable instructions further comprise instructions for the server to:
receive a designation, from the consumer, of at least some information in the account as information that may be provided to a third party without authorization from the consumer; and
designate the at least some of the information as information that may be provided to the third party only with authorization from the consumer.

8. The server of claim 1, wherein the processor-executable instructions further comprise instructions for the server to:
receive a designation, from the consumer, of at least some of the information in the account as information that may be provided to the third party only with authorization from the consumer during a transaction between the consumer and the third party; and
designate the at least some of the information as information that may be provided to the third party only with authorization from the consumer during a transaction between the consumer and the third party.

9. The server of claim 8, wherein the processor-executable instructions further comprise instructions for the server to:
receive a request for information in the account from the third party;
determine that the requested information has been designated as information that is provided to a third party only with authorization from the consumer;
send a request to the third party, for presentation to the consumer, for authorization to provide the requested information to the third party;
receive authorization to provide the requested information to the third party from the consumer, via the third party; and
provide the requested information to the third party.

10. The server of claim 1, wherein the processor-executable instructions further comprise instructions for the server to:
receive security token information related to a security token used by the consumer during future authentications with the server;
store the security token information in the account;
compare security token information provided in the login information to the security token information stored in the account; and
allow access to the account if the security token information provided in the login information matches the security token information stored in the account.

11. The server of claim 10, wherein the processor-executable instructions further comprise instructions for the server to:
receive a request, from the consumer, to require use of the security token information in a subsequent transaction with the server.

12. The server of claim of 1, wherein the processor-executable instructions further comprise instructions for the server to:
receive master security token information relating to a master security token that is used only to administer the account by the consumer; and
store the master security token information in the account.

13. The server of claim 1, wherein the processor-executable instructions further comprise instructions for the server to:
receive a designation, from the consumer, designating at least one of the data fields as allowed to be provided to third parties, not allowed to be given to third parties, or allowed to be provided to third parties only if the consumer provides authorization during a transaction between the consumer and a third party;
designating the at least one of the data fields as allowed to be provided to third parties, not allowed to be given to third parties, or allowed to be provided to third parties only if the consumer provides authorization during a transaction between the consumer and a third party in conformance with the consumer designation.

14. The server of claim 1, wherein one of the data fields comprises a data field for storing an identification of an entity that has verified a corresponding data entry.

15. The server of claim 1, wherein the processor-executable instructions further comprise instructions for the server to:
receive a request for authentication from a third party, the request comprising an indication of a minimum security level required by the third party to complete a transaction with the consumer; and
provide information from the account to the third party only if at least one of the security levels assigned to the account is equal to, or greater than, the minimum overall security level.

16. The server of claim 1, wherein the processor-executable instructions further comprise instructions for the server to:
receive a request for authentication from the third party, the request comprising an indication of a minimum number of authentication factors required by the third party to conduct a transaction with the consumer;
receive authentication information from the third party, provided by the consumer, the authentication information comprising a number of authentication factors; and
provide information from the account to the third party only if the received authentication information comprises at least the minimum level of authentication factors required by the third party.

17. The server of claim 2, wherein the processor-executable instructions that cause the server to add the new information comprises processor-executable instructions that cause the server to add information relating to a token provided to the consumer by the third party.

18. The server of claim 2, wherein the processor-executable instructions that cause the server to add the new information comprises processor-executable instructions that cause the server to add information relating to an airline boarding pass.
